(19) United States
(12) Patent Application Publication
(10) Pub. No.: US 2007/0250932 A1
(43) Pub. Date: Oct. 25, 2007

(54) Integrated enterprise-level compliance and risk management system

(76) Inventor: Pravin Kothari, San Jose, CA (US)

Correspondence Address: LEVINE BAGADE HAN LLP, 2483 EAST BAYSHORE ROAD, SUITE 100, PALO ALTO, CA, 94303, US

(21) Appl. No.: 11/407,838

(22) Filed: Apr. 20, 2006

(51) Int. Cl. G06F 11/00; G06F 12/14; G06F 12/16; G06F 15/18; G08B 23/00

(52) U.S. Cl. 726/25

(57) ABSTRACT

In one embodiment, the present invention includes a plurality of distributed software interfaces to interface with a plurality of assets on a network. The present invention can also include an asset module to discover the plurality of assets using the plurality of distributed software interfaces and to allow a user to configure the plurality of assets, and a policy module to allow a user to apply one or more of a set of policies to one or more of the plurality of assets and to analyze compliance with the set of policies. A policy editor can allow a user to add policies to the set of policies and to edit policies in the set of policies. Furthermore, the present invention can include a reporting module to report the compliance of the one or more assets with the one or more policies based on the analysis performed by the policy module.

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever.

### BACKGROUND

1. Field

Embodiments of the present invention apply to the field of network security and regulatory compliance, more specifically compliance management.

2. Description of the Related Art

Modern business enterprises operate in a complex regulatory environment. Many enterprises must comply with various government regulations both on the federal level and on the state and local levels. For example, most public corporations (at the present time any publicly traded corporation with fifty million or more market capitalization) must comply with the Sarbanes-Oxley Act of 2002. Financial enterprises, heath related enterprises, and other more stringently regulated industries have their own regulatory frameworks.

Furthermore, many business enterprises have internal policies and controls independent of government regulation. These controls and policies may be concerned with security, confidentiality maintenance, trade secret protection, access control, best practices, accounting standards, business process policies, and other such internal rules and controls. The cost of complying with all regulations, rules, policies, and other requirements can be substantial for a large scale business enterprise.

Up until the present time, large scale business enterprises have mostly used outside consultants to assist with compliance. The costs of such consultants can be staggering. Moreover, different consultants use different systems and checks, making it difficult to switch consultants. Some rudimentary efforts have been made to automate some of the task of compliance. However, what is needed, in an integrated compliance management system that can address both present and future compliance needs and integrates into an enterprises existing network infrastructure.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a block diagram illustrating a compliance management system according to one embodiment of the present invention;

FIG. 2 is a block diagram illustrating a user interface module for a compliance management system according to one embodiment of the present invention;

FIG. 3 is a flow diagram illustrating operation of the compliance management system according to one embodiment of the present invention; and

FIG. 4 is a block diagram illustrating an example computer system according to one embodiment of the present invention.

### DETAILED DESCRIPTION

Compliance and Risk Management System

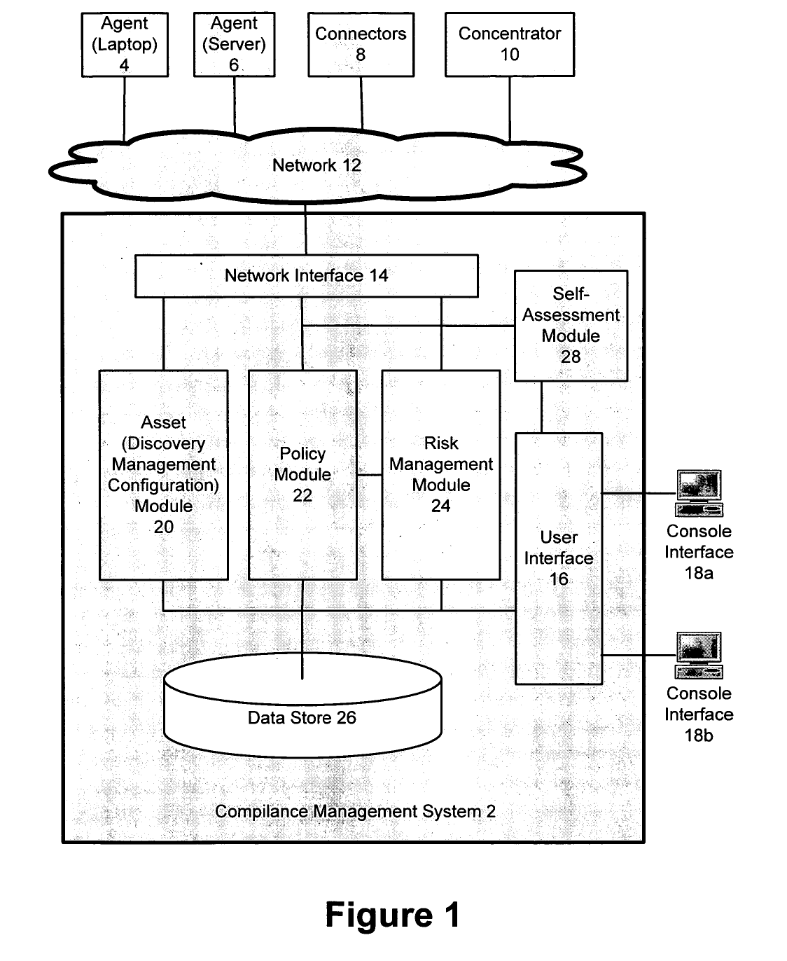

One embodiment of the invention is now described with reference to FIG. 1. FIG. 1 shows a compliance and risk management system 2, referred to hereafter simply as compliance management system 2. In one embodiment, the compliance management system 2 is provided as a stand-alone appliance that connects to a network, but the compliance management system 2 can be provided in other ways, such as software running on a server, distributed software, or various software and hardware packages operating together.

The compliance management system 2 connects to a network 12—such as an local area network (LAN), Intranet network segment, or the Internet—and can collect data from various sources. For example, the compliance management system 2 can collect data from agents 4 and 6. Agent 4 is an agent associated with and overseeing a laptop (in this example) and agent 6 is associated with a server. In a real-world embodiment, there could be thousands of agents associated with thousands of separate assets.

The compliance management system 2 can also collect information from various collectors 8. Collectors 8 can be custom designed connectors to connect to various network devices and network management and security products already installed by the enterprise. For example, the connectors 8 can enable the compliance management system 2 to connect to, and collect data from, routers, firewalls, directories (such as Microsoft's Active Directory), vulnerability scanners, security information management (SIM) products, enterprise risk management (ERM) products and other such products and applications. Also, some deployments of the compliance management system 2 may not use distributed agents at all, in which case information regarding various assets can be collected via an agent-less concentrator (also referred to sometimes as an aggregator) 10.

In one embodiment, the compliance management system 2 implements asset discovery, configuration, and management functionalities. Such functionality can be provided in the asset module 20 shown in FIG. 1. In one embodiment, the asset module interfaces with the various agents, connectors, and concentrators 2-10 (referred to collectively as “software interfaces” or “distributed software interfaces” for simplicity) via the network interface 14 that connects the compliance management system 2 to the network 12. The asset module 20 performs asset discovery by collecting information about all assets connected to and/or visible to the network 12. Such assets can include, but are not limited to, laptops, desktops, workstations, operating systems and other applications, servers, users, routers, intrusions detection devices (IDS), firewalls, printers, and storage systems. Assets can be imported from various connected applications, such as vulnerability scanners, directory applications, ERM, SIM, and other security-related products, and so on.

In one embodiment, the asset module 20 can also be used to configure asset attributes. This can be done by an operator of the compliance management system 2 via the user interface 16 exposed to the user by consoles 18a and 18b. There may be more or less consoles, which will be collectively referred to as console interface 18.

For example, an agent can report a newly discovered laptop computer. The agent can automatically report back on electrically available attributes, such as central processing unity (CPU) type, the operating system running on the laptop, the types of memory installed, and so on. A user (typically a system administrator) can then add extra attributes to the laptop, such as business owner, business classification, group, and other similar attributes.

The discovered and configured assets can be stored, in one embodiment, in data store 26. Data store 26 clan be implemented as a disk, a data server, or some other physical storage means. It can reside inside or outside of the compliance management system 2. The data store 26 can include various databases. One such database can be an asset database, having records corresponding with managed assets. The assets discovered and stored in the asset database can be managed, in one embodiment, from the console interface 18 by editing various attributes of the assets.

In one embodiment, policy compliance functionality is provided by the system 2 by implementing a policy module 22. The policy module 22 can enable a user—via the user interface 16—to author and edit policies and policy templates and apply policies to various assets. The policy module 22 also maintains a policy database in the data store 22. In one embodiment, policies can also be labeled, grouped and organized according to certain predefined roles for personnel. For example, “engineer level 1” can be a role that has a list of specific policies associated with it.

In one embodiment, the compliance management system 2 also provides risk management functionality by implementing a risk management module 24. The risk assessment module 24 analyzes multiple sources of information, including the compliance management system 2, to determine the risk the enterprise is exposed to. In one embodiment, the risk management module collects information—in addition to the compliance management system—from the enterprise's vulnerability assessment systems, SIM systems, asset configurations, and network traffic reports. Other sources of information may be used as well. In one embodiment, the risk management module determines a simple metric to express the enterprise's risk profile using all the collected information.

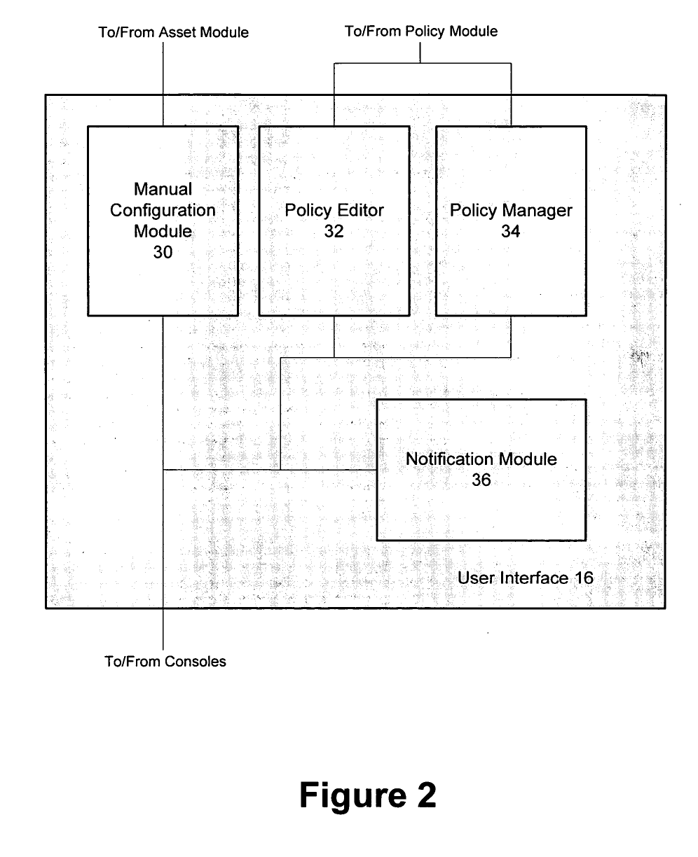

As mentioned above, the compliance management system 2 also includes a user interface 16 which is exposed to users of the system 2 by consoles 18. In one embodiment the consoles 18 are browser-based, allowing for administration and use of the system 2 from any network-attached work station, or through a remote network connection. In one embodiment, the user interface enables an administrator to select from a list of regulations—such as Sarbanes-Oxley (SOX), Gramm-Leach-Bliley Act (GLBA), Health Insurance Portability and Accountability Act (HIPPA), Card Holder Information Regulation Program (CISP)—and display functionality relevant to the selected regulation. Similarly, the user interface can enable an administrator to select from a list of standard frameworks—such as ISO-17799, Control Objectives for Information and related Technologies (COBIT)—and display functionality relevant to the selected regulation or framework. FIG. 2 provides a more detailed view of the user interface 16 according to one embodiment of the present invention.

The user interface 16 can implement a manual configuration module 30 that allows the user to manually configure asset attributes, as described in the example of the laptop being assigned to a business owner (and other user-defined attributes) above. The user interface can also implement a policy editor 32 and policy manager 34 to enable users to manage compliance. The policy editor 32 can assist users in naming and authoring policies.

The policy editor 32 can also provide access to a policy template database stored on the data store 26 having template policies. A user can then create a specific policy instance using a preconfigured template by saving the policy instance as a policy. The policy editor 32, in one embodiment, also includes access to a script-based policy language that allows for highly flexible authoring of almost any type of desired policy. In addition, the policy editor 32 can be used to edit saved policies and policies from various preconfigured policy databases as well as author and edit policy templates.

In one embodiment, the policies that can be authored by the policy editor 32 are highly flexible. Such policies include technology-based policies, such as password length and firewall configurations. Furthermore, some policies can be process related, ensuring that certain process owners take certain actions. Yet other types of polices can include some that cannot be automatically enforced in an information technology sense. For example, risk assessment surveys must be manually filled out by someone responsible for the domain being surveyed, and a policy can include the requiring of such a survey being filled out periodically. Since such policies require at least some human interaction, they are sometimes referred to herein as “manual” policies.

The user interface 16 can also implement a policy manager 34. The policy manager 34 allows the user to organize and apply policies. Policies can be associated with controls that are designed to mitigate against specific threats, as defined in various standards, such as ISO-17799. In one embodiment, the policy manager can be used to identify threats, define (or import) controls, and associate policies to controls to implement the controls. One control may be implemented using several policies, and a policy may be occasionally used in multiple controls. In one embodiment, policies are applied directly to assets or groups of assets. The user interface 16 can also include a notification module 36 to send alerts and reports regarding compliance management and risk analysis.

Returning to referencing FIG. 1, the compliance management system 2 can also include a self-assessment module 28. The self-assessment module 28 maintains and accesses various self-assessment surveys that can be stored in data store 26. The self-assessment module 28 may periodically, or under the direction of the policy module 22 or the user interface 16, send surveys to various individuals for completion. The self-assessment module 28 can analyze the results of such surveys and provide feedback to various other parts of the system 2.

System Operation

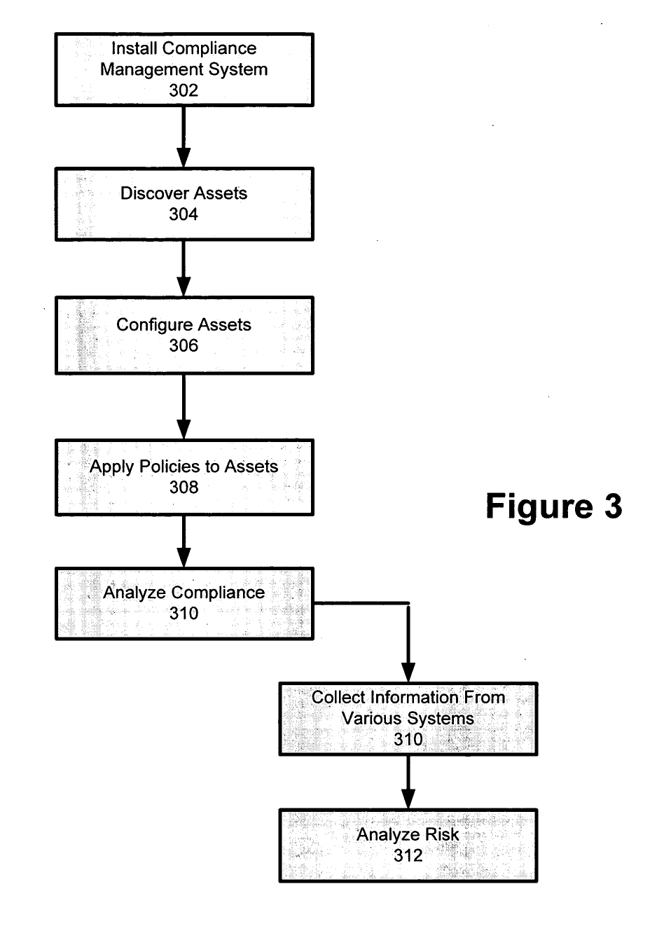

One embodiment of the compliance management system 2 in operation is now described with reference to FIG. 3. In block 302, the compliance management system is installed. This may be done by installing a software suite on a server or other computer, or by connecting a provisioned compliance appliance to a network.

In block 304, assets visible to the network are discovered. Such assets include, but are not limited to, computers, workstations, servers, printers, network devices, storage systems, and applications. Asset discovery can be performed by integrating the compliance management system with various enterprise tools, such as Active Directory, network scanners, and vulnerability scanners. Further asset discovery can come from various enterprise knowledge bases, such as a configuration management database (CMDB), or from agents distributed to various domains and network segments. In one embodiment, the compliance management system automatically distributes software agents to monitor and communicate with each asset. In other embodiments, agent-less techniques may be used to communicate with the assets.

In block 306, the assets are configured. This can be done automatically, manually, or as a combination of automatic and manual configuration. Configuring assets includes defining and setting attributes associated with each asset. Some asset attributes, such as asset location can be automatically defined and set by the compliance management system (in the case of asset location for example, by mapping an IP address to a physical location), while others such as business criticality or business impact may be manually configured.

In block 308, policies, both pre-provided and user-defined, are applied to the assets. For example a user can use a graphical interface to associate certain policies with asset groups containing assets. For example, a Password Length policy (requiring passwords to be at least 6 characters long, for example) can be associated with the Engineering group that includes all assets in the engineering department of the enterprise.

Then, in block 310 the compliance of the assets with the policies is analyzed. In some instances, where non-compliance is detected, the compliance management system can automatically enforce the policy not being complied with by, for example, controlling and re-configuring an asset using the agent associated with the assed. In other instances non-compliance is reported using various report formats including trouble tickets, business reports, and various graphs and charts.

In one embodiment, the compliance management system also analyzes collective risk to the enterprise. In such embodiment, in block 310, information from various systems, such as vulnerability scanners, IDSs, SIDs, network sniffers and other such systems, is collected. In block 312, all collected data, and the compliance analysis completed in block 310 is used to estimate the risk to which the enterprise is exposed.

Example Computer System

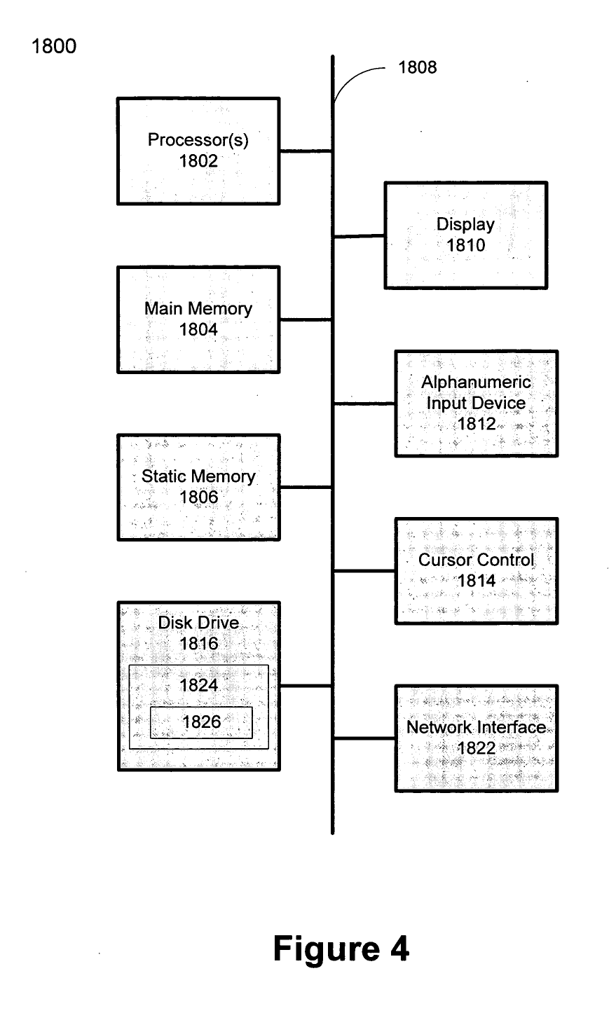

Various embodiments of the present invention have been described in the context of a server that performs compliance, security, and risk management functionalities, and a browser/console interface operable to access and view those functionalities. An example computer system on which such server and/or console interface can be implemented in now described with reference to FIG. 4. Numerous features described with reference to FIG. 4 can be omitted, e.g., a server will generally not include video display unit 1810. Computer system 1800 that may be used to perform one or more of the operations described herein. In alternative embodiments, the machine may comprise a network router, a network switch, a network bridge, Personal Digital Assistant (PDA), a cellular telephone, a web appliance or any machine capable of executing a sequence of instructions that specify actions to be taken by that machine.

The computer system 1800 includes a processor 1802, a main memory 1804 and a static memory 1806, which communicate with each other via a bus 1808. The computer system 1800 may further include a video display unit 1810 (e.g., a liquid crystal display (LCD) or a cathode ray tube (CRT)). The computer system 1800 also includes an alpha-numeric input device 1812 (e.g., a keyboard), a cursor control device 1814 (e.g., a mouse), a disk drive unit 1816, a signal generation device 1820 (e.g., a speaker) and a network interface device 1822.

The disk drive unit 1816 includes a machine-readable medium 1824 on which is stored a set of instructions (i.e., software) 1826 embodying any one, or all, of the methodologies described above. The software 1826 is also shown to reside, completely or at least partially, within the main memory 1804 and/or within the processor 1802. The software 1826 may further be transmitted or received via the network interface device 1822. For the purposes of this specification, the term “machine-readable medium” shall be taken to include any medium that is capable of storing or encoding a sequence of instructions for execution by the computer and that cause the computer to perform any one of the methodologies of the present invention. The term “machine-readable medium” shall accordingly be taken to included, but not be limited to, solid-state memories, optical and magnetic disks, and carrier wave signals.

General Matters

In the description above, for the purposes of explanation, numerous specific details have been set forth. However, it is understood that embodiments of the invention may be practiced without these specific details. In other instances, well-known circuits, structures and techniques have not been shown in detail in order not to obscure the understanding of this description.

Embodiments of the present invention include various processes. The processes may be performed by hardware components or may be embodied in machine-executable instructions, which may be used to cause one or more processors programmed with the instructions to perform the processes. Alternatively, the processes may be performed by a combination of hardware and software.

Embodiments of the present invention may be provided as a computer program product that may include a machine-readable medium having stored thereon instructions, which may be used to program a computer (or other electronic device) to perform a process according to one or more embodiments of the present invention. The machine-readable medium may include, but is not limited to, floppy diskettes, optical disks, compact disc read-only memories (CD-ROMs), and magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. A compliance management system comprising:
a plurality of distributed software interfaces to interface with a plurality of assets on a network;
an asset module to discover the plurality of assets using the plurality of distributed software interfaces and to allow a user to configure the plurality of assets;
a policy module to allow a user to apply one or more of a set of policies to one or more of the plurality of assets and to analyze compliance with the set of policies;
a policy editor to allow a user to add policies to the set of policies and to edit policies in the set of policies; and
a reporting module to report the compliance of the one or more assets with the one or more policies based on the analysis performed by the policy module.

2. The compliance management system of claim 1, further comprising a risk management module to analyze risk using information collected by the distributed software interfaces and the analysis performed by the policy module.

3. The compliance management system of claim 1, wherein the plurality of software interfaces comprises a plurality of distributed software agents, a plurality of connectors, and a plurality of connectors.

4. The compliance management system of 1, wherein the asset module allows the user to place a set of assets into an asset group.

5. The compliance management system of claim 4, wherein the policy module allows the user to apply a policy to the asset group.

6. The compliance management system of claim 1, wherein the asset module allows a user to assign a person to a role, the role including a pre-selected set of policies from the plurality of policies.

7. A method comprising:
collecting information from a plurality of software interfaces distributed over a network of an enterprise at a compliance management system;
discovering assets using the collected information;
configuring the discovered assets;
applying one or more policies to the configured assets;
analyzing a compliance of the assets with the one or more policies applied to the assets; and
reporting the results of the analysis to a user of the compliance management system.

8. The method of claim 7, wherein configuring the discovered assets comprises allowing the user to configure at least some of the discovered assets via a user interface of the compliance management system.

9. The method of claim 8, further comprising allowing the user to create the one of more policies via the user interface of the compliance management system.

10. The method of claim 7, further comprising analyzing enterprise risk based on the result of the analysis of the compliance of the assets with the one or more policies.

11. The method of claim 7, wherein applying one or more policies to the configured assets comprises automatically sending a survey to a business owner of an asset.

12. The method of claim 11, wherein analyzing the compliance of the assets with the one or more policies comprises analyzing the compliance of the asset using answers supplied by the business owner of the asset.

13. A machine-readable medium having stored thereon data representing instructions that, when executed by a processor, cause the processor to perform operations comprising:
collecting information from a plurality of software interfaces distributed over a network of an enterprise at a compliance management system;
discovering assets using the collected information;
configuring the discovered assets;
applying one or more policies to the configured assets;
analyzing a compliance of the assets with the one or more policies applied to the assets; and
reporting the results of the analysis to a user of the compliance management system.

14. The machine-readable medium of claim 13, wherein configuring the discovered assets comprises allowing the user to configure at least some of the discovered assets via a user interface of the compliance management system.

15. The machine-readable medium of claim 14, wherein the instructions further cause the processor to provide an interface to the user to create the one of more policies.

16. The machine-readable medium of claim 13, wherein the instructions further cause the processor to analyze enterprise risk based on the result of the analysis of the compliance of the assets with the one or more policies.

17. The machine-readable medium of claim 13, wherein applying one or more policies to the configured assets comprises automatically sending a survey to a business owner of an asset. 18. The machine-readable medium of claim 17, wherein analyzing the compliance of the assets with the one or more policies comprises analyzing the compliance of the asset using answers supplied by the business owner of the asset.
